(19) United States
(12) Patent Application Publication
(10) Pub. No.: US 2026/0167848 A1
(43) Pub. Date: Jun. 18, 2026

(54) PRIMER COMPOSITION IN THERMALLY DETACHABLE MULTILAYER STRUCTURE BONDED WITH THERMOSETTING ADHESIVES

(71) Applicant: Dow Global Technologies LLC, Midland, MI (US)

(72) Inventors: Yongchun Chen, Shanghai (CN); Qingwei Meng, Shanghai (CN); Guo Zeng, Shanghai (CN); Jiguang Zhang, Shanghai (CN); Ming Yu, Shanghai (CN); Yang Liu, Shanghai (CN); Qi Gao, Shanghai (CN); Shouxue Guo, Shanghai (CN); Yi Zhang, Shanghai (CN); Shaoguang Feng, Shanghai (CN)

(21) Appl. No.: 19/125,323

(22) PCT Filed: Nov. 21, 2022
(86) PCT No.: PCT/CN2022/133262

§ 371 Date: Apr. 29, 2025

(51) Int. Cl. C09J 7/29; H01M 50/227; H01M 50/231; H01M 50/233; H01M 50/249; H01M 50/264

(52) U.S. Cl. CPC C09J 7/29; H01M 50/227; H01M 50/231; H01M 50/233; H01M 50/249; H01M 50/264; C09J 2203/33; C09J 2301/16; C09J 2301/304; H01M 2220/20

(57) ABSTRACT

Thermoplastic primer compositions may include a high surface energy thermoplastic resin having a surface energy of 37 dynes/cm or greater, at a percent by weight (wt %) of 55 wt % to 90 wt %; a low surface energy thermoplastic resin having a surface energy of less than 37 dynes/cm, at 10 wt % to 45 wt %; wherein the thermoplastic primer composition has a glass transition temperature in the range of 60° C. to 120° C. Multilayer compositions may include a substrate having a surface energy of 37 dynes/cm or greater; a primer layer containing a thermoplastic primer composition; and one or more thermoset adhesive layers.

### FIELD

Embodiments relate to methods and systems including thermoplastic polymer blends used in detachable battery assemblies and other applications.

### INTRODUCTION

Thermoplastic and thermoset adhesives are utilized in a number of industrial applications, including flexible packaging, and mounting electric vehicle (EV) batteries. For most applications, thermoset adhesives are selected on the basis of bonding strength, substate compatibility, and long term durability under operating conditions. For a number of applications, however, adhered components must be separated for maintenance or replacement of parts. In order to detach an EV battery bonded to a thermoset adhesive layer, for example, physical removal methods are typically used, such as prying, cutting, or laser ablation. Other approaches involve the use of solvents or acids to remove the thermoset adhesive, which can generate chemical hazards and may provide limited penetration into an adhesive layer. Another concern with common detachment methods is the effectiveness in high surface area attachments, including those present in EV battery packs, which can lead to damage to adhered components.

### SUMMARY

Thermoplastic primer compositions may include a high surface energy thermoplastic resin having a surface energy of 37 dynes/cm or greater, at a percent by weight (wt %) of 55 wt % to 90 wt %; a low surface energy thermoplastic resin having a surface energy of less than 37 dynes/cm, at 10 wt % to 45 wt %; wherein the thermoplastic primer composition has a glass transition temperature in the range of 60° C. to 120° C.

### DETAILED DESCRIPTION

Embodiments relate to thermoplastic primer compositions containing a blend of two or more resins having differing surface energies. Particularly, thermoplastic primer compositions may include a high surface energy thermoplastic resin having a surface energy of 37 dynes/cm or greater, and a low surface energy thermoplastic resin having a surface energy of 37 dynes/cm or less. In some cases, thermoplastic primer compositions may be incorporated in a multilayer structure as a thermoplastic primer layer that enables temperature-dependent detachment of a thermoset adhesive layer from one or more high surface energy (>37 dynes/cm) substrates.

Surface energy measurements provide a quantitative estimate of the polar character of a polymer and compatibility for adherence to high energy substrates. Surface energy may be calculated based on the surface free energy (SFE) of solids, utilizing contact angle measurements. Surface free energy is closely related with cohesive energy (E), and can be divided into three parts corresponding to atomic dispersion (E_{d}), molecular dipolar interactions (Eₚ), and hydrogen-bonding interactions (Eₕ). SFE can be calculated based on three factors: 1) dispersion (δ_{d}), 2) polarity (δₚ), and 3) hydrogen-bonding forces (δₕ). The surface energy is calculated using the Owens-Wendt method from the contact angles of water (18 ohm deionized water), which are measured on a contact angle goniometer by the Sessile Drop method.

In general, polymers having higher surface energies of 34 dynes/cm or more adhere to a broad variety of solid and foamed polar polymer products, such as polyurethanes, than polymers having lower surface energies such as polyolefins (often 32 dynes/cm or less). Thermoplastic primer compositions disclosed herein may enable tunable adhesive strength to high surface energy substrates by blending two or more thermoplastic polymers, such that the primer compositions exhibit good adhesive properties at temperatures below 60° C. and become detachable at elevated temperatures.

Electric vehicle battery designs often include one or more battery packs containing a plurality of battery cells that are individually bonded to various types of substrates. EV batteries may also include a number of external features to protect battery packs and battery cell arrays, including a number of housings and substrates. With the large surface contact areas of battery components (e.g., around 0.5 m² for a pack block to 1.5 m² for a whole pack) and broad working temperature ranges (e.g., −20° C. to 60° C.), thermoset adhesives are often employed to provide bonding strength between the battery and underlying or above substrates and structures. The bonding strength of thermoset adhesives, however, makes it difficult to detach battery packs or pack substrates without damaging adhered components.

Methods and systems disclosed herein are directed to thermoplastic primer compositions that may be used as part of multilayer adhesive compositions for removably securing battery components (e.g., battery packs, battery cells) to various types of substrates. Multilayer compositions may include one or more thermoplastic primer composition layers and one or more thermoset adhesive layers interspersed between two substrates, such as one or more battery cells and pack substrates (e.g., battery pack cover, battery pack bottom, or thermal management plate). Thermoplastic primer layers disclosed herein may melt or soften at elevated temperature (e.g., 60° C. to 120° C.), which reduces the bonding strength of the multilayer composition and enables the automatic or mechanically-assisted release of the thermoplastic primer composition from attached surfaces (e.g., high surface energy substrates, thermoset adhesive layer, etc.).

Thermoplastic primer compositions disclosed herein may be prepared as a primer layer that is detachably bonded to one or more of a thermoset adhesive layer and one or more substrates. Thermoplastic primer layers may remain solid and maintain adhesive performance throughout operating temperatures for most applications (e.g., below or up to 50° C.), but soften and/or melt at temperatures above the glass transition temperature (T_{g}) or melt point temperature (Tₘ) of the thermoplastic adhesive. Thermoplastic primer layers disclosed herein may have glass transition temperatures (T_{g}) that range from 60° C. to 130° C., 60° C. to 120° C., 60° C. to 110° C., or 60° C. to 90° C.

Multilayer compositions may include a high surface energy substrate onto which one or more thermoplastic primer compositions are formed, applied, or deposited. Examples of high surface energy substrates also include surfaces of battery components (e.g., battery pack or cell frame), substrate packs, thermal management plates, and other surfaces. Battery components disclosed herein may include EV battery packs and substrates, including prismatic or pouch cell-based batteries, cylindrical cell batteries, battery packs, and the like.

As used herein, “high surface energy substrate” refers to substrates having a surface energy of 37 dynes/cm or greater. High surface energy substrates disclosed herein include metals such as aluminum, steel or alloys, zinc, and the like, non-metals, including glass, polar polymers such as epoxy, polyurethane, or polyester, coated materials such as epoxy-coated aluminum, polyacrylate-coated aluminum, polyester liner-covered aluminum, and the like. Table 1 includes additional examples of suitable high energy substrates.

TABLE 1
Surface energy measurements for selected substrates

| | Surface Energy |
|---|---|
| Substrate | (dynes/cm) |
| Copper | 1103 |
| Aluminum | 840 |
| Stainless Steel | 700-1100 |
| Zinc | 753 |
| Tin | 526 |
| Lead | 458 |
| Glass | 250-500 |
| Polyimide | 50 |
| Styrene butadiene rubber | 48 |
| Phenolic | 47 |
| Nylon | 46 |
| Polyether sulfone | 46 |
| Polycarbonate | 46 |
| Epoxy | 43 |
| Polyethylene terephthalate | 43 |
| Polyurethane | 43 |
| ABS | 42 |

High surface energy substrates may also be placed into contact with a multilayer composition containing one or more thermoplastic primer compositions that are assembled on a second substrate or surface. In some cases, multilayer composition may contain a thermoplastic primer layer contacting a high surface energy substrate, and a thermoset adhesive contacting the thermoplastic primer layer. The thermoset adhesive may also mediate adhesion to a second substrate, such as a thermal management plate.

Multilayer compositions may include one or more thermoset adhesive layer, which can include one or more polyurethane, epoxy, polyacrylate, polyester, crosslinked derivatives thereof, and the like. Thermoset adhesives may include structural adhesives and/or thermal conductive adhesives having a thermal conductance of 0.2 W/mK or more, such as in a range of 0.2 W/mK to 3 W/mK. Thermoset adhesives disclosed herein may be water-borne, solvent-borne, or solventless.

Thermoplastic primer compositions may include thermoplastic resins and polymers having mixed surface energy, including a first high surface energy thermoplastic resin, and a second low surface energy thermoplastic resin. High surface energy thermoplastic resins include polar thermoplastic polymers and resins substituted with carboxyl, hydroxyl, and other polar groups having a surface energy of 37 dynes/cm or greater. High surface energy polymers and resins include thermoplastics such as polyurethane, polyacrylic, polyethylene terephthalate (PET), polyesters, epoxies, polyethers, polycarbonates, and the like.

Non-limiting examples of high surface energy thermoplastic resins are shown in Table 2.

TABLE 2
Measurements for selected high surface energy thermoplastic resins

| | Surface Energy |
|---|---|
| Resin | (dynes/cm) |
| Polyimide | 50 |
| Styrene butadiene rubber | 48 |
| Polyphenylene oxide | 47 |
| Phenolic resin | 47 |
| Nylon (6,6) | 46 |
| Polyethersulfone | 46 |
| Polyester | 43 |
| Epoxy | 43 |
| Polyurethane | 43 |
| ABS | 42 |
| Polycarbonate | 42 |
| Polyethylene terephthalate | 42 |
| Polymethyl methacrylate | 41 |
| Polyvinyl Chloride | 39 |
| Acrylic | 38 |

The first high surface energy thermoplastic resin may have a glass transition temperature in the range of 50° C. to 120° C., or 60° C. to 110° C. Resin formulations of the high surface energy thermoplastics may have a solids content at a percent by weight in a suitable solvent of 55 wt % to 95 wt %, or 65 wt % to 95 wt %.

Thermoplastic primer compositions may include a second low surface energy thermoplastic resin having a surface energy of less than 37 dynes/cm. Low surface energy thermoplastic resins may include maleic anhydride grafted polymers and prepolymers such as maleic anhydride grafted polyolefin (MAH-g-POE), maleic anhydride grafted ethylene-vinyl acetate (MAH-g-EVA), maleic anhydride grafted styrene-ethylene-butylene-styrene (MAH-g-SEBS), and the like. In some cases, the grafted polyolefin is not a halogenated polyolefin. Non-limiting examples of low surface energy thermoplastic resins are shown in Table 3.

TABLE 3
Measurements for selected low surface energy thermoplastic resins

| | Surface Energy |
|---|---|
| Resin | (dynes/cm) |
| Acetal | 36 |
| Acrylonitrile butadiene styrene | 35 |
| Polystyrene | 34 |
| Ethylene vinyl acetate (EVA) | 33 |
| Polybutylene terephthalate | 32 |
| Polyethylene | 31 |
| Polychlorotrifluoroethylene | 31 |
| Polypropylene | 29 |
| Polyvinylfluoride | 25 |
| Polydimethylsiloxane | 23 |
| Polytetrafluoroethylene | 18 |

In addition to maleic acid, examples of reactive compounds that can be grafted onto the polymeric hydrocarbon backbone include ethylenically unsaturated carboxylic acids such as fumaric acid, itaconic acid, acrylic acid, methacrylic acid, crotonic acid, glycidyl acrylate, glycidyl methacrylate, and the like; acid anhydrides such as maleic anhydride and itaconic anhydride, and the like. The degree of incorporation or grafting of the reactive compounds may depend on the application and, in some cases, may be at a percent by weight (wt %) of up to 10 wt %, 5 wt %, 2 wt %, or 1 wt %, and not less than 0.01 wt %, 0.1 wt %, or 0.2 wt %.

The second low surface energy thermoplastic resin may have a glass transition temperature in the range of 50° C. to 120° C., or 60° C. to 110° C. Resin formulations of the low surface energy thermoplastics may have a solids content at a percent by weight in a suitable solvent of 5 wt % to 45 wt %, or 5 wt % to 35 wt %.

In some cases, the polarity of a thermoplastic primer composition layer may be tuned to minimize changes in lap shear strength and cross tensile strength resulting from incompatibility with the thermoset adhesive layer. For example, a thermoplastic primer compositions may be modified to include more or less high surface energy resins to increase the adhesion to polar thermoset resins such as polyurethanes and epoxies, or to decrease the melt temperature of the layer for detachment purposes. Thermoplastic primer compositions may have a ratio of high surface energy resin to low surface energy resin of 55:45 or greater, 70:30 or greater, or in a range of 55:45 to 90:10, or 70:30 to 90:10.

Thermoplastic primer compositions may also contain additives, including tackifier resins such as rosins, terpenes and modified terpenes, aliphatic, cycloaliphatic and aromatic resins (e.g., C5 aliphatic resins, C9 aromatic resins, and C5/C9 aliphatic/aromatic resins), hydrogenated hydrocarbon resins, terpene-phenol resins, novolacs, and the like; organic phase change materials (PCM) such as hydrocarbons, paraffins (e.g., CₙH₂ₙ₊₂) and lipids with 60° C. to 120° C. phase-changing temperatures; and liquid crystalline materials having phase change properties in a temperature range of 60° C. to 120° C.; and the like.

Thermoplastic primer composition layers may be applied to an adhesive layer and/or substrate layer as a solid, thin film, hot melt, or powder (e.g., 100 wt % solids). Thermoplastic primer layers may be generated by solvating the first and/or second thermoplastic resins, optionally with one or more additional thermoplastic polymers, in a suitable solvent, and depositing the resulting solvated resin composition on a substrate or surface. The solvent is then allowed to evaporate as the thermoplastic primer layer is formed. Suitable solvents may vary depending on the solubility of the selected primer resin or resin mixture, and may include aqueous or organic solvents. Mixtures of nonpolar and polar organic solvents may be used. Nonpolar solvents may include cycloalkyl or aromatic species such as toluene, methyl cyclohexane, and the like. Polar organic solvents may include methyl ethyl ketone, ethyl acetate, butyl acetate, and the like.

Organic solvated resin compositions may include one or more primer resins (e.g., solids) at a percent by weight (wt %) in a range of 1 wt % to 35 wt %, 1 wt % to 20 wt %, or 3 wt % to 20 wt %. Organic solvated resin compositions may include a nonpolar organic solvent at a percent by weight (wt %) in a range of 60 wt % to 99 wt %, 65 wt % to 99 wt %, or 70 wt % to 99 wt %. Organic solvated resin compositions may include a polar organic solvent at a percent by weight (wt %) in a range of 1 wt % to 40 wt %, 1 wt % to 45 wt %, or 1 wt % to 30 wt %.

Waterborne resin compositions may include one or more primer resins at a percent by weight (wt %) in a range of 15 wt % to 65 wt %, 20 wt % to 60 wt %, or 30 wt % to 55 wt %. Aqueous solvated resin compositions may include an aqueous fluid at a percent by weight (wt %) in a range of 35 wt % to 85 wt %, 40 wt % to 80 wt %, or 45 wt % to 70 wt %.

Thermoplastic primer layers disclosed herein may maintain good bonding strength relative to a bond between an adhesive layer and a substrate. Multilayer compositions disclosed herein may have a lap shear strength at room temperature that having less than a 30% decrease relative to a comparative multilayer composition without a thermoplastic primer composition layer. Multilayer compositions disclosed herein may have a cross tensile strength at room temperature that having less than a 30% decrease relative to a comparative multilayer composition without a thermoplastic primer layer.

Methods of preparing detachable multilayer compositions disclosed herein may include providing a substrate surface, one or more thermoplastic primer composition layers, and one or more thermoset adhesive layers. Thermoplastic primer composition layers and thermoset adhesive layers may be produced by solid deposition or by coating from solvent composition using known methods such as roller coating, flow coating, dip coating, spin coating, spray coating, knife coating, and die coating. Multilayer compositions disclosed herein may include a thermoplastic primer layer having a thickness in a range of 5 μm to 150 μm, 10 μm to 100 μm, or 10 μm to 60 μm.

Systems may include a detachable electric vehicle battery system, including an electrical vehicle battery; a multilayer composition adhering the battery to a pack substate, the multilayer composition including one or more thermoplastic primer layers having a transition temperature in the range of 60° C. to 120° C., and one or more thermoset adhesive layers; a heat source in contact with the multilayer composition or functioning as a layer thereof (e.g., the thermoplastic primer layer or thermoset adhesive layer is bonded directly to a thermal management plate or other heat source); and wherein the pack substrate is one or more of a pack bottom, pack cover, or the heat source; wherein the heat source is configured to heat the multilayer composition to a detachment temperature in the range of 60° C. to 120° C. to enable detachment of the electric vehicle battery.

Methods of detaching a battery pack adhered to a substrate by a multilayer composition may include heating the multilayer composition to a “detachment temperature” above 60° C. to induce softening or melting of the thermoplastic primer layers, followed by separating one or more layers of the multilayer composition to detach the battery pack from the substrate. Detachment methods may include mechanically separating the primer and/or adhesive layer from the substrate layer by a suitable technique such as prying, wedging, and/or impact. In some cases, gravity or other “passive” technique may be used to separate one or more layers of the multilayered composition.

Application of heat to a multilayer composition may include use of an external heat source such as an electric heating platform, electric heating pad, electric heating sheet, electric heating blanket, or the like, or an internal heat source such as the thermal management plate, thermal management pad, embedded heat elements, and the like.

During heating and detachment of the multilayer composition, methods and systems may utilize direct heating of the multilayer composition to minimize the measured temperature of the battery pack. If the battery cells are directly bonded with a substrate (e.g., a thermal management plate in EV battery pack), the substrate can function as an internal heat source. If the battery cells are directly bonded with pack substrate (e.g., bottom or cover in EV battery pack), the heat source may also be external, such as thermal management platform/pad/blanket contacting the multilayer composition. In either case, the use of an external or internal heat source produces an initial temperature increase at the contact site (e.g., the thermoplastic primer layer and/or thermoset adhesive layer), while the limitations of heat transfer result in delayed heating of distant components (e.g., a battery cell).

### EXAMPLES

The following examples are provided to illustrate the embodiments of the invention, but are not intended to limit the scope thereof. All parts and percentages are by weight unless otherwise indicated. Table 4 lists the materials used in the following examples:

TABLE 4
Components used in the examples

| | | | Melting | |
|---|---|---|---|---|
| | | | point | |
| Component | Description | | (° C.) | Supplier |
| TPU | Thermoplastic polyurethane | HF-3H95 | 73 | Huafon |
| PET | Thermoplastic | Bester 648 | <70 | Bester |
| | polyethyleneterephthalate (PET) | | | |
| Acrylate | Thermoplastic polyacrylate | TAR669 | >55 | Kaster |
| | solution (50% solid) | | | |
| MAH-g-EVA, | Maleic anhydride grafted | BYNEL E 418 | 74 | Dow |
| 0.25-0.5% MAH | ethylene-vinyl acetate | | | |
| MAH-g- | Maleic anhydride grafted | FUSABOND ® | 71 | Dow |
| EVA, >1%- | ethylene-vinyl acetate | C250 | | |
| MAH | | | | |
| MAH-g- | Maleic anhydride grafted | Amplify | 62.7 | Dow |
| POE, >0.5%- | polyolefin | GR216 | | |
| MAH | | | | |
| MAH-g-SEBS, | Maleic anhydride grafted | Kraton ® | <75 | Kraton |
| 1.4-2.0% MAH | Styrene-ethylene-butylene- | FG1901 | | |
| | styrene | | | |
| MAH-g-CPO | Maleic anhydride grafted | HARDLEN ® | 70 | Toyobo |
| | chlorinated polyolefin | F-2P | | |
| EVA, 40% VA | ethylene-vinyl acetate | Elvax ® 40L-03 | 58 | Dow |
| EVA, 28% VA | ethylene-vinyl acetate | Elvax ® 250 | 70 | Dow |
| E-BA-GMA, | Ethylene, butyl acrylate and | ELVALOY ® | 72 | Dow |
| 21% BA, 9% | glycidyl methacrylate copolymer | 4170 | | |
| GMA | | | | |
| 2K polyurethane | Voratron ™ MA8202S | — | — | Dow |
| adhesive | | | | |
| Methyl | — | — | — | Sigma- |
| cyclohexane | | | | Aldrich |
| Methyl ethyl | — | — | — | Sigma- |
| ketone | | | | Aldrich |

Lap shear strength testing was carried out according to GB/T 7124. Substrates tested included epoxy coated type-3 aluminum (3003), Type-3 aluminum (3003) and Type-5 aluminum (5754) with 2.5 mm thickness and 25 mm*12.5 mm surface area. Substrate surfaces were cleaned with ethanol and brush coated with a thermoplastic primer composition and dried. Thermoset adhesives were applied by mixing isocyanate components and isocyanate-reactive components under vacuum conditions, and 0.5 g to 1.5 g of adhesive was applied to the substrate. Along the length direction, a second substrate with the same bonding area was applied to the adhesive layer. Pressure was applied and the multilayer compositions were cured at 23° C. for 7 days. Lap shear strength was tested using an Instron testing system. A lap shear strength of ≥8 MPa is desirable.

Cross tensile strength tests were carried out according to GB/T 6329. Substrates tested included epoxy coated Type-3 aluminum (3003) with a cylinder of 60 mm height and 15 mm diameter. Prior to treatment, the cylinder head surface was cleaned, and the thermoplastic primer composition was applied and dried. Comparative samples without primer treatment were also prepared. Adhesive compositions were then prepared and 0.5 g to 1.0 g was applied to the substrate. A second substrate was applied, and the flat surfaces of the substrates were bonded together by curing at 23° C. for 7 days. Cross tensile strength was measured by Instron tensile testing machine. A cross tensile strength of ≥8 MPa is desirable.

Detachment testing was conducted with a lab-established qualitative method with the following process:
1) Substrate surfaces (100 mm*150 mm*2 mm) are cleaned by wiping off with ethanol.
2) Substrates are then coated with primer by brush, dried. Comparative samples were also prepared without primer treatment.
3) Thermoset adhesive layers were prepared by combining Part A and Part B of a 2K PU adhesive in speed mixer at 1,000 rpm for 1 min.
4) Approximately 10 g to 15 g of the adhesive is applied to the substrate using two copper wires with diameter 1 mm to control layer thickness.
5) A second substrate was then stacked lengthwise. The bonding surfaces of the substrate are then contacted and held in place with clips. The adhered substrates were then cured at 23° C. for 7 days.
6) Before detaching test, samples were heated in an oven for 10 mins at 80° C.
7) Samples were then removed and fixed by bend clamp, while a screwdriver was used to manually pry the substrates apart. Detachment under 1 minute is regarded as “successful.” “Failure” was indicated by two modes: cohesive failure (adhesive on both sides after detaching) and adhesive failure (adhesive on one side after detaching).

### Example 1: Thermoplastic Primer Composition Application to Type-3 Aluminum

In this example, thermoplastic resins samples having different surface energies were prepared and adhesion performance and detachability were surveyed against comparative primer compositions. Primer composition samples were prepared by solubilization in toluene at 5 wt % of resin with heating and stirring at 80° C. for 1 hour. The resulting solution was then cooled and transferred to a sealed vessel. Toluene was used as a solvent for thermoplastic polyurethane (TPU), polyethylene terephthalate (PET) and maleic acid grafted ethylenevinyl acetate (MAH-g-EVA), and toluene alone or as a blend with cellosolve was used for acrylate-based resins.

Type-3 Al substrates (either epoxy-coated or uncoated) were first coated with a 5 wt % thermoplastic primer composition solution and bonded by a 2K PU thermosetting adhesive (Voratron™ MA8202S). Following a period of aging at room temperature for a week, cross tensile strength and detaching properties were measured. For comparison, blank sample without primer treatment is also prepared and applied in the test.

Results are summarized in Table 5. Suitable adhesive performance is indicated as having a lap shear strength of 8 MPa or more at room temperature, and a cross tensile strength 8 MPa or more at room temperature. Of particular note, the thermoplastic primer compositions in IE4 and IE5 containing TPU+MAH-g-EVA and Acrylate+MAH-g-EVA (weight ratio is around 8/2) provided high shear strength at lower temperatures and enabled detachment at elevated temperatures.

TABLE 5
Test results on Type-3 Al plate

| | | | Lap | Lap | Cross | Cross | |
|---|---|---|---|---|---|---|---|
| | | | shear | shear | tensile | tensile | |
| | | | strength@ | strength@ | strength@ | strength@ | Detaching |
| | | | 23° C. | 80° C. | 23° C. | 80° C. | test @ |
| Samples. | Primer | | (MPa) | (MPa) | (MPa) | (MPa) | 80° C. |
| CE1 | no | | 13.75 | 2.85 | 15.60 | 3.00 | Failed |
| CE2 | TPU + MAH- | (0:10) | 5.50 | 0.35 | 5.90 | 0.20 | Passed |
| CE3 | g-EVA1 | (5:5) | 6.50 | 0.45 | 6.20 | 0.45 | Passed |
| IE1 | (0.25-0.5% | (7:3) | 11.25 | 0.90 | 8.50 | 1.30 | Passed |
| IE2 | MAH) | (8:2) | 10.70 | 1.40 | 9.15 | 0.95 | Passed |
| IE3 | | (9:1) | 10.95 | 1.75 | 8.55 | 1.00 | Passed |
| CE4 | | (10:0) | 13.10 | 2.55 | 13.80 | 3.30 | Failed |
| IE4 | TPU + MAH- | (8:2) | 10.40 | 1.20 | 13.20 | 0.85 | Passed |
| | g-EVA2 | | | | | | |
| | (>1%-MAH) | | | | | | |
| CE6 | TPU + EVA 1 | (8:2) | 4.55 | 0.40 | 4.65 | 0.35 | Passed |
| | (40% VA) | | | | | | |
| CE7 | TPU + EVA 2 | (8:2) | 5.15 | 0.60 | 2.20 | 0.25 | Passed |
| | (28% VA) | | | | | | |
| CE8 | TPU + E-BA- | (8:2) | 5.10 | 0.55 | 3.10 | 0.25 | Passed |
| | GMA (21% | | | | | | |
| | BA, 9% GMA) | | | | | | |
| CE9 | TPU + MAH- | (8:2) | 5.90 | 0.70 | 5.90 | 0.55 | Passed |
| | g-POE | | | | | | |
| | (>0.5%-MAH) | | | | | | |
| CE10 | TPU + MAH- | (8:2) | 7.00 | 0.60 | 4.40 | 0.50 | Passed |
| | g-SEBS | | | | | | |
| | (1.4-2.0% | | | | | | |
| | MAH) | | | | | | |
| CE11 | Acrylate + | (5:5) | 7.40 | 1.00 | 6.20 | 0.50 | Passed |
| IE5 | MAH-g-EVA1 | (8:2) | 10.50 | 1.40 | 8.90 | 0.65 | Passed |
| CE12 | (0.25-0.5% | (10:0) | 15.90 | 2.30 | 14.60 | 2.35 | Failed |
| | MAH) | | | | | | |
| CE13 | PET + MAH- | (8:2) | 8.40 | 1.30 | 6.45 | 0.30 | Passed |
| CE14 | g-EVA1 | (10:0) | 11.95 | 3.05 | 14.50 | 1.90 | Failed |
| | (0.25-0.5% | | | | | | |
| | MAH) | | | | | | |

### Example 2: Thermoplastic Primer Composition Application to Epoxy-Coated Type-3 Al

In this example, thermoplastic primer compositions and samples were prepared as described in Example 1. Following a period of aging at room temperature for a week, cross tensile strength and detaching properties were measured. For comparison, blank sample without primer treatment is also prepared and applied in the test.

Results are summarized in Table 6. Of particular note, the thermoplastic primer compositions in IE2, IE7, and IE8 (weight ratio is around 8/2) provided high shear strength at lower temperatures and enabled detachment of the 2K PU adhesive at elevated temperatures.

TABLE 6
Test results on epoxy-coated Type-3 Al plate

| | | | Lap | Lap | Cross | Cross | |
|---|---|---|---|---|---|---|---|
| | | | shear | shear | tensile | tensile | |
| | | | strength@ | strength@ | strength@ | strength@ | Detaching |
| | | | 23° C. | 80° C. | 23° C. | 80° C. | test @ |
| Exam. | Primer | | (MPa) | (MPa) | (MPa) | (MPa) | 80° C. |
| CE1 | no | | 20.30 | 7.00 | 17.55 | 2.85 | Failed |
| CE2 | TPU + MAH- | 0:10 | 6.50 | 0.55 | 5.40 | 0.42 | Passed |
| CE3 | g-EVA1 | 5:5 | 7.50 | 0.55 | 6.30 | 0.50 | Passed |
| IE1 | (0.25-0.5% | 7:3 | 12.80 | 0.80 | 12.80 | 0.80 | Passed |
| IE2 | MAH) | 8:2 | 18.50 | 1.75 | 14.40 | 1.20 | Passed |
| IE3 | | 9:1 | 16.50 | 1.85 | 15.10 | 1.60 | Passed |
| CE4 | | 10:0 | 21.30 | 6.00 | 17.40 | 2.60 | Failed |
| IE4 | TPU + MAH- | 8:2 | 13.70 | 1.20 | 15.70 | 1.00 | Passed |
| | g-EVA2 | | | | | | |
| | (>1% MAH) | | | | | | |
| CE5 | TPU + EVA 1 | 8:2 | 8.90 | 0.50 | 7.55 | 0.55 | Passed |
| | (40% VA) | | | | | | |
| CE6 | TPU + EVA 2 | 8:2 | 12.00 | 0.75 | 5.00 | 0.40 | Passed |
| | (28% VA) | | | | | | |
| IE5 | TPU + E-BA- | 8:2 | 12.35 | 0.80 | 8.35 | 0.45 | Passed |
| | GMA (21% | | | | | | |
| | BA, 9% GMA) | | | | | | |
| IE6 | TPU + MAH- | 8:2 | 12.05 | 1.15 | 8.05 | 0.70 | Passed |
| | g-POE | | | | | | |
| | (>0.5%-MAH) | | | | | | |
| CE7 | TPU + MAH- | 8:2 | 10.20 | 0.90 | 7.55 | 0.75 | Passed |
| | g-SEBS | | | | | | |
| | (1.4-2.0% | | | | | | |
| | MAH) | | | | | | |
| CE8 | Acrylate + | 5:5 | 10.30 | 1.45 | 7.30 | 1.60 | Passed |
| IE7 | MAH-g- | 8:2 | 21.50 | 2.80 | 15.30 | 2.30 | Passed |
| CE9 | EVA1 (0.25- | 10:0 | 21.45 | 5.20 | 17.20 | 2.50 | Failed |
| | 0.5% MAH) | | | | | | |
| IE8 | PET + MAH- | 8:2 | 16.25 | 1.95 | 10.40 | 1.34 | Passed |
| | g-EVA1 | | | | | | |
| | (0.25-0.5% | | | | | | |
| | MAH) | | | | | | |
| CE10 | PET + MAH- | 10:0 | 15.85 | 4.60 | 16.15 | 2.40 | Failed |
| | g-EVA1 | | | | | | |
| | (0.25-0.5% | | | | | | |
| | MAH) | | | | | | |

While the foregoing is directed to exemplary embodiments, other and further embodiments may be devised without departing from the basic scope thereof, and the scope thereof is determined by the claims that follow.

1. A thermoplastic primer composition, comprising:
a high surface energy thermoplastic resin having a surface energy of 37 dynes/cm or greater, at a percent by weight (wt %) of 55 wt % to 90 wt %;
a low surface energy thermoplastic resin having a surface energy of less than 37 dynes/cm, at 10 wt % to 45 wt %;
wherein the thermoplastic primer composition has a glass transition temperature in the range of 60° C. to 120° C.

2. The composition of claim 1, wherein the weight ratio of the high surface energy thermoplastic resin and the low surface energy thermoplastic resin is 55/45 or greater.

3. The composition of claim 1, wherein the high surface energy thermoplastic resin is one or more selected from a group consisting of polyurethane, polyesters, epoxies, polyacrylates, and polycarbonates.

4. The composition of claim 1, wherein the second thermoplastic polymer is a maleic anhydride grafted chlorinated polyolefin having a maleic anhydride grafting degree of greater than 1%.

5. The composition of claim 1, wherein the second thermoplastic polymer is one or more of a group consisting of maleic anhydride grafted polyolefin (MAH-g-POE), maleic anhydride grafted ethylene-vinyl acetate (MAH-g-EVA), maleic anhydride grafted and styrene-ethylene-butylene-styrene (MAH-g-SEBS).

6. A thermoplastic primer layer prepared by solubilizing the high surface energy thermoplastic resin and the low surface energy thermoplastic resin in an organic solvent, and applying the solubilized resin to a substrate.

7. A multilayer composition, comprising:
a substrate having a surface energy of 37 dynes/cm or greater;
a primer layer comprising the primer composition of claim 1; and
one or more thermoset adhesive layers.

8. The multilayer composition of claim 1, wherein the cross tensile strength of the multilayer composition has less than a 30% decrease at 23° C. relative to a comparative multilayer composition without the one or more thermoplastic primer layers.

9. The multilayer composition of claim 5, wherein the primer layer has a thickness ranging from 10 μm to 100 μm.

10. An electric vehicle battery assembly comprising the multilayer composition of claim 1.
